(19) United States
(12) Patent Application Publication
(10) Pub. No.: US 2025/0300243 A1
(43) Pub. Date: Sep. 25, 2025

(54) SEPARATOR, SECONDARY BATTERY, AND ELECTRONIC APPARATUS

(71) Applicant: Ningde Amperex Technology Limited, Ningde (CN)

(72) Inventor: Minjing CHEN, Ningde (CN)

(73) Assignee: Ningde Amperex Technology Limited, Ningde (CN)

(21) Appl. No.: 19/084,765

(22) Filed: Mar. 20, 2025

(30) Foreign Application Priority Data
Mar. 21, 2024 (CN) 202410330696.8

(51) Int. Cl. H01M 10/42; H01M 10/0525; H01M 10/0567; H01M 10/0569; H01M 50/417; H01M 50/449; H01M 50/489

(52) U.S. Cl. CPC H01M 10/4235; H01M 10/0525; H01M 10/0567; H01M 10/0569; H01M 50/417; H01M 50/449; H01M 50/489; H01M 2300/0034; H01M 2300/0037

(57) ABSTRACT

A separator includes a polyethylene base film and a coating provided on at least one surface of the polyethylene base film, where a pore closing temperature of the separator is T1, a pore closing temperature of the polyethylene base film is T2, and 3° C.≤T2−T1≤17° C.; and the separator has a porosity P of 15% to 55% after being placed at 110° C. for 10 min. When the separator is used, during drop process of the secondary battery, a pore closing tendency of the separator can block reactions between positive and negative electrodes. This can improve the drop performance of the secondary battery at high temperatures and effectively improve the intermittent cycling performance of the secondary battery at high temperatures.

### CROSS-REFERENCE TO RELATED APPLICATION

This application claims priority to the Chinese Patent Application Serial No. 202410330696.8, filed on Mar. 21, 2024, the content of which is incorporated herein by reference in its entirety.

### TECHNICAL FIELD

This application relates to the field of electrochemical technologies, and in particular, to a separator, a secondary battery, and an electronic apparatus.

### BACKGROUND

With increasingly high requirements on secondary batteries such as lithium-ion batteries, secondary batteries have been widely used in various fields such as portable electronic devices, electric bicycles, electric vehicles, and energy storage devices. Higher operating voltages, higher energy densities, and more diversified usage scenarios have been continuously imposed on lithium-ion batteries. In recent years, the thermal safety issues of lithium-ion batteries at high temperatures have continuously attracted public attention. The intermittent cycling performance degradation and drop of lithium-ion batteries at high temperatures easily cause fires and explosions, posing serious safety hazards to users. Therefore, increasing research is performed on the intermittent cycling performance and drop performance of lithium-ion batteries at high temperatures.

### SUMMARY

This application is intended to provide a separator, a secondary battery, and an electronic apparatus to improve the drop performance and intermittent cycling performance of the secondary battery at high temperatures.

It should be noted that in the specification of this application, an example in which a lithium-ion battery is used as a secondary battery is used to illustrate this application. However, the secondary battery in this application is not limited to the lithium-ion battery. Specific technical solutions are described as follows.

A first aspect of this application provides a separator including a polyethylene base film and a coating provided on at least one surface of the polyethylene base film, where a pore closing temperature of the separator is T1, a pore closing temperature of the polyethylene base film is T2, and 3° C.≤T2−T1≤17° C.; and the separator has a porosity P of 15% to 55% after being placed at 110° C. for 10 min. In some embodiments of this application, 25%≤P≤45%. When the difference T2−T1 between the pore closing temperature of the polyethylene base film and the pore closing temperature of the separator and the porosity P fall within the ranges in this application, during drop of the secondary battery, a pore closing tendency of the separator can block reactions between positive and negative electrodes. This can improve the drop performance of the secondary battery at high temperatures and effectively improve the intermittent cycling performance of the secondary battery at high temperatures.

In some embodiments of this application, 132° C.≤T1≤142° C., and/or 136° C.≤T2≤146° C. Controlling the values of T1 and T2 within the above ranges can better block the reactions between the positive and negative electrodes during drop of the secondary battery at high temperatures, thereby further improving the drop performance and intermittent cycling performance of the secondary battery at high temperatures.

In some embodiments of this application, after the separator is placed at 110° C. for 30 min, an area percentage of the molten coating covering the polyethylene base film is A, and 72%≤A≤85%. The area percentage A falling within the above range can better block the reactions between the positive and negative electrodes during drop of the secondary battery at high temperatures, thereby further improving the drop performance and intermittent cycling performance of the secondary battery at high temperatures.

In some embodiments of this application, the coating includes a first material and a second material; a melt flow rate MFR1 of the first material is 8 g/10 min to 17 g/10 min; and a melt flow rate MFR2 of the second material is 0.5 g/10 min to 2.5 g/10 min. The coating obtained by controlling the melt flow rates of the first material and the second material within the above ranges has suitable melt flow characteristics at high temperatures, so that pores of the separator can be quickly closed at high temperatures, thereby better blocking the reactions between the positive and negative electrodes during drop of the secondary battery at high temperatures, and further improving the drop performance and intermittent cycling performance of the secondary battery at high temperatures.

In some embodiments of this application, the first material and the second material are each independently selected from at least one of polyethylene or polypropylene. The coating obtained by selecting the above first material and second material has suitable melt flow characteristics at high temperatures, so that pores of the separator can be quickly closed at high temperatures, thereby better blocking the reactions between the positive and negative electrodes during drop of the secondary battery at high temperatures, and further improving the drop performance and intermittent cycling performance of the secondary battery at high temperatures.

In some embodiments of this application, a mass ratio of the first material to the second material is 1:(1 to 4.5). Controlling the mass ratio X within the above range allows the separator to have a more suitable material structure and strength, thereby better blocking the reactions between the positive and negative electrodes during drop of the secondary battery at high temperatures, and further improving the drop performance and intermittent cycling performance of the secondary battery at high temperatures.

A second aspect of this application provides a secondary battery including a positive electrode plate, a negative electrode plate, an electrolyte, and the separator according to any one of the foregoing embodiments. Thus, the secondary battery provided in this application has good drop performance and intermittent cycling performance at high temperatures.

In some embodiments of this application, the electrolyte includes a lithium salt, a solvent, and an additive; the additive includes ethylene sulfate and vinylene sulfate; and based on a total mass of the electrolyte, a mass percentage of ethylene sulfate is W1, and a mass percentage of vinylene sulfate is W2, where 0.1≤W1/W2≤2, and 0.2%≤W1≤1%. Introducing the above additives into the electrolyte and controlling W1/W2 and W1 within the above ranges can suppress the thickness swelling of the secondary battery at high temperatures, improve the intermittent cycling performance of the secondary battery, further improve the drop performance of the secondary battery, and improve the low-temperature cycling performance of the secondary battery.

In some embodiments of this application, 0.1%≤W2≤5%. Controlling W2 within the above range can suppress the thickness swelling of the secondary battery at high temperatures, further improve the drop performance and intermittent cycling performance of the secondary battery, and improve the low-temperature cycling performance of the secondary battery.

In some embodiments of this application, the electrolyte further includes a nitrile compound and a fluorine compound; and based on the total mass of the electrolyte, a mass percentage of the nitrile compound is W3, and a mass percentage of the fluorine compound is W4, where 0.28≤W3/W4≤2, and 0.6%≤W4≤4.2%;
the nitrile compound includes at least one of a compound represented by formula [1] or a compound represented by formula [2]:

CN-R1-CN formula [1]; and

CN-R2-(O-R3)n-O-R4-CN formula [2];
where R1, R2, R3, and R4 are each independently an alkylene group with 1 to 5 carbon atoms or an alkenylene group with 2 to 5 carbon atoms, and n represents an integer from 0 to 5; and
the fluorine compound includes at least one of fluoroethylene carbonate, fluoroethyl methyl carbonate, difluoroethylene carbonate, or 1,1,2,2-tetrafluoroethyl-2,2,3,3-tetrafluoropropyl ether.

Introducing the above nitrile compound and fluorine compound into the electrolyte and controlling W3/W4 and W4 within the above ranges can suppress the thickness swelling of the secondary battery at high temperatures, improve the intermittent cycling performance of the secondary battery, further improve the drop performance of the secondary battery, and improve the low-temperature cycling performance of the secondary battery.

In some embodiments of this application, the nitrile compound includes at least one of adiponitrile or butanedinitrile. Selecting the above nitrile compound in synergy with the fluorine compound suppresses the thickness swelling of the secondary battery at high temperatures, further improves the drop performance and intermittent cycling performance of the secondary battery, and improves the low-temperature cycling performance of the secondary battery.

In some embodiments of this application, the electrolyte further includes 3-(diphenylphosphino)benzenesulfonate lithium; and based on the total mass of the electrolyte, a mass percentage W5 of 3-(diphenylphosphino)benzenesulfonate lithium is 1% to 4%. The electrolyte including the above amount of 3-(diphenylphosphino)benzenesulfonate lithium can reduce the amount of gas generated during cycling of the secondary battery, improve the high-temperature cycling performance of the secondary battery, and further improve the drop performance and intermittent cycling performance.

In some embodiments of this application, a surface resistance R of the negative electrode plate is 0.002 mΩ/cm² to 0.008 mΩ/cm². The adaption of the negative electrode plate with suitable surface resistance can more effectively reduce the gas generated at a negative electrode interface at high temperatures, thereby improving the cycling performance of the secondary battery at high temperatures.

A third aspect of this application provides an electronic apparatus including the secondary battery according to any one of the foregoing embodiments.

This application has the following beneficial effects.

This application provides a separator, a secondary battery, and an electronic apparatus. The separator includes a polyethylene base film and a coating provided on at least one surface of the polyethylene base film, where a pore closing temperature of the separator is T1, a pore closing temperature of the polyethylene base film is T2, and 3° C.≤T2−T1≤17° C.; and the separator has a porosity P of 15% to 55% after being placed at 110° C. for 10 min. When the difference T2−T1 between the pore closing temperature of the polyethylene base film and the pore closing temperature of the separator and the porosity P fall within the ranges in this application, during drop of the secondary battery, a pore closing tendency of the separator can block reactions between positive and negative electrodes. This can improve the drop performance of the secondary battery at high temperatures and effectively improve the intermittent cycling performance of the secondary battery at high temperatures.

Certainly, when any product or method of this application is implemented,

all advantages described above are not necessarily demonstrated simultaneously.

### DETAILED DESCRIPTION

The following clearly describes the technical solutions in some embodiments of this application. Apparently, the described embodiments are only some but not all of these embodiments of this application. All other embodiments obtained by persons skilled in the art based on this application shall fall within the protection scope of this application.

A first aspect of this application provides a separator including a polyethylene base film and a coating provided on at least one surface of the polyethylene base film, where a pore closing temperature of the separator is T1, a pore closing temperature of the polyethylene base film is T2, and 3° C.≤T2−T1≤17° C. In some embodiments of this application, 3° C.≤T2−T1≤14° C. For example, T2−T1 may be 3° C., 5° C., 7° C., 9° C., 10° C., 11° C., 13° C., 15° C., 16° C., or 17° C., or falls within a range defined by any two of these values. The separator has a porosity P of 15% to 55% after being placed at 110° C. for 10 min. In some embodiments of this application, 25%≤P≤45%. For example, the porosity P may be 15%, 20%, 25%, 30%, 35%, 40%, 45%, 50%, or 55%, or falls within a range defined by any two of these values. The above “a coating provided on at least one surface of the polyethylene base film” means that the coating may be provided on one surface of the polyethylene base film in its thickness direction or on both surfaces of the polyethylene base film in its thickness direction. It should be noted that the “surface” herein may be an entire region of the surface of the polyethylene base film or a partial region of the surface of the polyethylene base film. This is not particularly limited in this application, provided that the objectives of this application can be achieved.

When T2−T1 is excessively small, for example, less than 3° C., pore closing temperatures of material components of the polyethylene base film and coating in the separator are excessively approximate. When pores of the materials are closed at the same or similar temperatures, an overall pore closing range of the separator is short, thus reducing the drop test pass rate of the secondary battery at high temperatures. When T2−T1 is excessively large, for example, greater than 17° C., there is an excessively large difference in the pore closing temperatures of the material components of the polyethylene base film and coating in the separator, causing the overall pore closing range of the separator to be excessively long. When pores of some materials are closed and then a separator breakage temperature is reached first, short circuits are likely to occur, thus reducing the drop test pass rate of the secondary battery at high temperatures. When the porosity P is excessively small, for example, less than 15%, the air permeability of the separator is poor, thus affecting the charging and discharging performance of the secondary battery. When the porosity P is excessively large, for example, greater than 55%, the air tightness of the separator is poor, leading to degradation in the drop performance of the secondary battery. Therefore, when the difference T2−T1 between the pore closing temperature of the polyethylene base film and the pore closing temperature of the separator and the porosity P fall within the ranges in this application, during drop of the secondary battery, a suitable pore closing range and pore closing tendency of the separator can block reactions between positive and negative electrodes, so that the drop performance of the secondary battery at high temperatures can be improved. In addition, the separator satisfying the above characteristics has no effect on the transport speed of lithium ions, so that the intermittent cycling performance of the secondary battery at high temperatures can also be improved. In this application, the porosity refers to a percentage of a pore volume in a bulk volume of the separator; and the high temperature refers to a temperature greater than or equal to 35° C.

In some embodiments of this application, 129° C.≤T1≤142° C., and/or 136° C.≤T2≤150° C. In some embodiments of this application, 132° C.≤T1≤142° C., and/or 136° C.≤T2≤146° C. For example, T1 may be 129° C., 130° C., 131° C., 132° C., 134° C., 135° C., 136° C., 137° C., 138° C., 139° C., 140° C., 141° C., or 142° C., or falls within a range defined by any two of these values. For example, T2 may be 136° C., 137° C., 138° C., 139° C., 140° C., 141° C., 142° C., 143° C., 144° C., 145° C., 146° C., 147° C., 148° C., 149° C., or 150° C., or falls within a range defined by any two of these values. The separator obtained by controlling the values of T1 and T2 within the above ranges may have a suitable pore closing tendency and a suitable pore closing range, thereby better blocking the reactions between the positive and negative electrodes during drop of the secondary battery at high temperatures, and further improving the drop performance and high-temperature intermittent cycling performance of the secondary battery at high temperatures.

In some embodiments of this application, after the separator is placed at 110° C. for 30 min, an area percentage of the molten coating covering the polyethylene base film is A, and 72%≤A≤85% For example, the area percentage A may be 72%, 74%, 76%, 77%, 79%, 81%, 82%, 84%, or 85%, or falls within a range defined by any two of these values. The area percentage A falling within the above range indicates that pores of the separator can be quickly closed at high temperatures, thereby better blocking the reactions between the positive and negative electrodes during drop of the secondary battery at high temperatures, and further improving the drop performance and intermittent cycling performance of the secondary battery at high temperatures.

In some embodiments of this application, the coating includes a first material and a second material; a melt flow rate MFR1 of the first material is 8 g/10 min to 17 g/10 min; and a melt flow rate MFR2 of the second material is 0.5 g/10 min to 2.5 g/10 min. For example, the melt flow rate MFR1 of the first material may be 8 g/10 min, 10 g/10 min, 12 g/10 min, or 17 g/10 min, or falls within a range defined by any two of these values. The melt flow rate of the second material may be 0.5 g/10 min, 1 g/10 min, 1.5 g/10 min, 2 g/10 min, or 2.5 g/10 min, or falls within a range defined by any two of these values. The coating obtained by controlling the melt flow rates of the first material and the second material within the above ranges has suitable melt flow characteristics at high temperatures, so that pores of the separator can be quickly closed at high temperatures and has a suitable pore closing tendency and a suitable pore closing range, thereby better blocking the reactions between the positive and negative electrodes during drop of the secondary battery at high temperatures, and further improving the drop performance and intermittent cycling performance of the secondary battery at high temperatures.

In some embodiments of this application, the first material and the second material are each independently selected from at least one of polyethylene or polypropylene. The coating obtained by selecting the above first material and second material has suitable melt flow characteristics at high temperatures, so that pores of the separator can be quickly closed at high temperatures, thereby better blocking the reactions between the positive and negative electrodes during drop of the secondary battery at high temperatures, and further improving the drop performance and intermittent cycling performance of the secondary battery at high temperatures.

In some embodiments of this application, a mass ratio X of the first material to the second material is 1:(1 to 4.5). For example, the mass ratio X may be 1:1, 1:1.1, 1:1.5, 1:2, 1:2.5, 1:3, 1:3.5, 1:4, or 1:4.5, or falls within a range defined by any two of these values. Controlling the mass ratio X within the above range allows the separator to have a suitable pore closing tendency and pore closing temperature as well as excellent strength, thereby better blocking the reactions between the positive and negative electrodes during drop of the secondary battery at high temperatures, and further improving the drop performance and intermittent cycling performance of the secondary battery at high temperatures.

In some embodiments of this application, the coating may further include a dispersant and a wetting agent. Types and amounts of the dispersant and the wetting agent are not particularly limited in this application, provided that the objectives of this application can be achieved. For example, the dispersant may include but is not limited to at least one of sodium carboxymethyl cellulose (CMC-Na), polyethylene glycol octylphenyl ether (Triton X-100 or T-100), or polyvinylpyrrolidone (PVP). The wetting agent may include but is not limited to at least one of dimethylsiloxane, polyoxyethylene alkylphenol ether, polyoxyethylene fatty alcohol ether, polyoxyethylene polyoxypropylene block copolymer, or polyether-modified trimethylsiloxane. For example, based on a mass of the coating, mass percentages of the dispersant and the wetting agent are each independently 0.8% to 2.2%.

In this application, a first material and second material with different melt flow rates can be purchased, and a first material and second material with desired melt flow rates can be selected with reference to a test method for “melt flow rate test” provided in this application.

In this application, polyethylene base films with different pore closing temperatures can be purchased, and a polyethylene base film with a desired pore closing temperature can be selected with reference to a test method for “pore closing temperature test for polyethylene base film” provided in this application.

Thicknesses of the polyethylene base film and the coating are not limited in this application, provided that the objectives of this application can be achieved. For example, the thickness of the polyethylene base film may be 4 μm to 10 μm, and the thickness of the coating may be 2 μm to 7 μm.

A second aspect of this application provides a secondary battery including a positive electrode plate, a negative electrode plate, an electrolyte, and the separator according to any one of the foregoing embodiments. Thus, the secondary battery provided in this application has good drop performance and intermittent cycling performance at high temperatures.

In some embodiments of this application, the electrolyte includes a lithium salt, a solvent, and an additive; the additive includes ethylene sulfate and vinylene sulfate; and based on a total mass of the electrolyte, a mass percentage of ethylene sulfate is W1, and a mass percentage of vinylene sulfate is W2, where 0.1≤W1/W2≤2, and 0.2%≤W1≤1%. For example, the value of W1/W2 may be 0.1, 0.3, 0.6, 0.7, 1, 1.5, or 2, or falls within a range defined by any two of these values. For example, W1 may be 0.2%, 0.3%, 0.4%, 0.5%, 0.6%, 0.7%, 0.8%, 0.9%, or 1%, or falls within a range defined by any two of these values. The above additives are introduced into the electrolyte, and W1/W2 and W1 are controlled within the above ranges, so that during charging and discharging of the secondary battery, uniform and dense solid electrolyte interface films (SEI films or CEI films) are formed at interfaces of positive and negative electrodes, thereby reducing the continuous occurrence of redox and side reactions of the electrolyte at the interfaces, suppressing the thickness swelling of the secondary battery at high temperatures, and improving the intermittent cycling performance of the secondary battery. In addition, during drop of the secondary battery, the above solid electrolyte interface films can alleviate the issues of high temperatures in partial regions, thereby further improving the drop performance of the secondary battery. Moreover, this is conducive to alleviating lithium precipitation at the negative electrode interface at low temperatures, thereby improving the low-temperature cycling performance of the secondary battery. In this application, the low temperature refers to a temperature less than or equal to 20° C.

In some embodiments of this application, 0.1%≤W2≤5%. For example, W2 may be 0.1%, 0.5%, 1%, 1.5%, 2%, 2.5%, 3%, 3.5%, 4%, 4.5%, or 5%, or falls within a range defined by any two of these values. Controlling W2 within the above range allows the amounts of ethylene sulfate and vinylene sulfate to synergize with each other, further reducing the continuous occurrence of redox and side reactions of the electrolyte at the interfaces of the positive and negative electrodes, thereby suppressing the thickness swelling of the secondary battery at high temperatures, further improving the drop performance and intermittent cycling performance of the secondary battery, and alleviating lithium precipitation at the negative electrode interface to improve the low-temperature cycling performance of the secondary battery.

In some embodiments of this application, the electrolyte further includes a nitrile compound and a fluorine compound; and based on the total mass of the electrolyte, a mass percentage of the nitrile compound is W3, and a mass percentage of the fluorine compound is W4, where 0.28≤W3/W4≤2, and 0.6%≤W4≤4.2%. For example, the value of W3/W4 may be 0.28, 0.29, 0.3, 0.5, 0.7, 0.9, 1, 1.2, 1.4, 1.5, 1.7, 1.9, or 2, or falls within a range defined by any two of these values. For example, W4 may be 0.6%, 0.8%, 1%, 1.5%, 2%, 2.5%, 3%, 3.5%, 4%, or 4.2%, or falls within a range defined by any two of these values. When the electrolyte includes the above amounts of nitrile compound and fluorine compound, these two different types of compounds can synergistically form more uniform and dense solid electrolyte interface films with resistance to oxidative decomposition and reductive decomposition at the interfaces of the positive and negative electrodes during charging and discharging of the secondary battery, thereby reducing the continuous occurrence of redox and side reactions of the electrolyte at the interfaces, suppressing the thickness swelling of the secondary battery at high temperatures, and improving the intermittent cycling performance of the secondary battery. In addition, during drop of the secondary battery, the above solid electrolyte interface films can alleviate the issues of high temperatures in partial regions, thereby further improving the drop performance of the secondary battery. Moreover, this is conducive to alleviating lithium precipitation at the negative electrode interface at low temperatures, thereby improving the low-temperature cycling performance of the secondary battery.

In some embodiments of this application, 0.5%≤W3≤4.5%. For example, W3 may be 0.5%, 1%, 1.5%, 2%, 2.5%, 3%, 3.5%, 4%, or 4.5%, or falls within a range defined by any two of these values.

In some embodiments of this application, the nitrile compound includes at least one of a compound represented by formula [1] or a compound represented by formula [2]:

CN-R1-CN formula [1]; and

CN-R2-(O-R3)n-O-R4-CN formula [2];
where R1, R2, R3, and R4 are each independently an alkylene group with 1 to 5 carbon atoms or an alkenylene group with 2 to 5 carbon atoms, and n represents an integer from 0 to 5. For example, the alkylene group with 1 to 5 carbon atoms may be a methylene group, an ethylene group, a propylidene group, a butylidene group, or a pentylidene group; the alkenylene group with 2 to 5 carbon atoms may be an ethenylidene group, a propenylidene group, a butenylidene group, or a pentylene group; and n may be 0, 1, 2, 3, 4, or 5.

In some embodiments of this application, the nitrile compound includes at least one of adiponitrile or butanedinitrile. Selecting the above nitrile compound in synergy with the fluorine compound can reduce the continuous occurrence of redox and side reactions of the electrolyte at the interfaces of the positive and negative electrodes, suppress the thickness swelling of the secondary battery at high temperatures, further improve the drop performance and intermittent cycling performance of the secondary battery, and alleviate lithium precipitation at the negative electrode interface to improve the low-temperature cycling performance of the secondary battery.

In some embodiments of this application, the fluorine compound includes at least one of fluoroethylene carbonate, fluoroethyl methyl carbonate, difluoroethylene carbonate, or 1,1,2,2-tetrafluoroethyl-2,2,3,3-tetrafluoropropyl ether. Selecting the above fluorine compound in synergy with the nitrile compound can reduce the continuous occurrence of redox and side reactions of the electrolyte at the interfaces of the positive and negative electrodes, suppress the thickness swelling of the secondary battery at high temperatures, and alleviate lithium precipitation at the negative electrode interface to improve the low-temperature cycling performance of the secondary battery.

In some embodiments of this application, the electrolyte further includes 3-(diphenylphosphino)benzenesulfonate lithium; and based on the total mass of the electrolyte, a mass percentage W5 of 3-(diphenylphosphino)benzenesulfonate lithium is 1% to 4%. For example, W5 may be 1%, 1.5%, 2%, 2.5%, 3%, 3.5%, or 4%, or falls within a range defined by any two of these values. The electrolyte including the above amount of 3-(diphenylphosphino)benzenesulfonate lithium can capture gas molecules generated at the positive electrode interface during high-temperature charging and discharging of the secondary battery, thereby reducing the occurrence of side reactions at the positive electrode interface, reducing the amount of gas generated during cycling of the secondary battery, improving the high-temperature cycling performance of the secondary battery, and further improving the drop performance and intermittent cycling performance.

The lithium salt is not particularly limited in this application, provided that the objectives of this application can be achieved. For example, the lithium salt may include but is not limited to at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), or lithium difluoroborate. The amount of the lithium salt in the electrolyte is not particularly limited in this application, provided that the objectives of this application can be achieved. For example, based on the mass of the electrolyte, a mass percentage of the lithium salt is 8% to 15%.

The solvent is not particularly limited in this application, provided that the objectives of this application can be achieved. For example, the solvent may include but is not limited to at least one of a carbonate compound, a carboxylate compound, an ether compound, or another organic solvent. The carbonate compound may include but is not limited to at least one of a linear carbonate compound, a cyclic carbonate compound, or a fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethylene propyl carbonate (EPC), or methyl ethyl carbonate (MEC). The cyclic carbonate may include but is not limited to at least one of ethylene carbonate (EC), propylene carbonate (PC), butylene carbonate (BC), or vinyl ethylene carbonate (VEC). The fluorocarbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran. The another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The amount of the non-aqueous solvent in the electrolyte is not particularly limited in this application, provided that the objectives of this application can be achieved. The amount of the solvent in the electrolyte is not particularly limited in this application, provided that the objectives of this application can be achieved. For example, based on the mass of the electrolyte, a mass percentage of the solvent is 62% to 89%.

In some embodiments of this application, the electrolyte includes ethylene sulfate, vinylene sulfate, a lithium salt, and a solvent. Based on the mass of the electrolyte, mass percentages of ethylene sulfate, vinylene sulfate, and the lithium salt are as described above, and a mass percentage of the solvent is 79% to 89%. When the electrolyte includes ethylene sulfate and vinylene sulfate, the obtained secondary battery has reduced thickness swelling rate, improved low-temperature cycling performance, and further improved drop performance and intermittent cycling performance.

In some embodiments of this application, the electrolyte includes a nitrile compound, a fluorine compound, a lithium salt, and a solvent. Wherein, based on the mass of the electrolyte, mass percentages of the nitrile compound, fluorine compound, and lithium salt are as described above, and a mass percentage of the solvent is 72% to 89%. When the electrolyte includes the nitrile compound and the fluorine compound, the obtained secondary battery has reduced thickness swelling rate, improved low-temperature cycling performance, and further improved drop performance and intermittent cycling performance.

In some embodiments of this application, the electrolyte includes 3-(diphenylphosphino)benzenesulfonate lithium, a lithium salt, and a solvent. Based on the mass of the electrolyte, mass percentages of 3-(diphenylphosphino)benzenesulfonate lithium and the lithium salt are as described above, and a mass percentage of the solvent is 81% to 89%. When the electrolyte includes 3-(diphenylphosphino)benzenesulfonate lithium, the obtained secondary battery has reduced amount of gas generated during cycling, improved high-temperature cycling performance, and further improved drop performance and intermittent cycling performance.

In some embodiments of this application, the electrolyte includes ethylene sulfate, vinylene sulfate, a nitrile compound, a fluorine compound, a lithium salt, and a solvent. Based on the mass of the electrolyte, mass percentages of ethylene sulfate, vinylene sulfate, the nitrile compound, the fluorine compound, and the lithium salt are as described above, and a mass percentage of the solvent is 66% to 89%. When the electrolyte includes ethylene sulfate, vinylene sulfate, the nitrile compound, and the fluorine compound, the obtained secondary battery has reduced thickness swelling rate, improved low-temperature cycling performance, and further improved drop performance and intermittent cycling performance.

In some embodiments of this application, the electrolyte includes ethylene sulfate, vinylene sulfate, 3-(diphenylphosphino)benzenesulfonate lithium, a lithium salt, and a solvent. Based on the mass of the electrolyte, mass percentages of ethylene sulfate, vinylene sulfate, 3-(diphenylphosphino)benzenesulfonate lithium, and the lithium salt are as described above, and a mass percentage of the solvent is 75% to 89%. When the electrolyte includes sulfate, ethylene vinylene sulfate, and 3-(diphenylphosphino)benzenesulfonate lithium, the obtained secondary battery has reduced thickness swelling rate, improved low-temperature cycling performance, reduced amount of gas generated during cycling, improved high-temperature cycling performance, and further improved drop performance and intermittent cycling performance.

In some embodiments of this application, the electrolyte includes a nitrile compound, a fluorine compound, 3-(diphenylphosphino)benzenesulfonate lithium, a lithium salt, and a solvent. Based on the mass of the electrolyte, mass percentages of ethylene sulfate, vinylene sulfate, 3-(diphenylphosphino)benzenesulfonate lithium, and the lithium salt are as described above, and a mass percentage of the solvent is 68% to 89%. When the electrolyte includes the nitrile compound, the fluorine compound, and 3-(diphenylphosphino)benzenesulfonate lithium, the obtained secondary battery has reduced thickness swelling rate, improved low-temperature cycling performance, reduced amount of gas generated during cycling, improved high-temperature cycling performance, and further improved drop performance and intermittent cycling performance.

In some embodiments of this application, the electrolyte includes ethylene sulfate, vinylene sulfate, a nitrile compound, a fluorine compound, 3-(diphenylphosphino)benzenesulfonate lithium, a lithium salt, and a solvent. Based on the mass of the electrolyte, mass percentages of ethylene sulfate, vinylene sulfate, the nitrile compound, the fluorine compound, 3-(diphenylphosphino)benzenesulfonate lithium, and the lithium salt are as described above, and a mass percentage of the solvent is 62% to 89%. When the electrolyte includes ethylene sulfate, vinylene sulfate, the nitrile compound, the fluorine compound, and 3-(diphenylphosphino)benzenesulfonate lithium, the obtained secondary battery has reduced thickness swelling rate, improved low-temperature cycling performance, reduced amount of gas generated during cycling, improved high-temperature cycling performance, and further improved drop performance and intermittent cycling performance.

In some embodiments of this application, a surface resistance R of the negative electrode plate is 0.002 mΩ/cm² to 0.008 mΩ/cm². For example, R may be 0.002 mΩ/cm², 0.003 mΩ/cm², 0.004 mΩ/cm², 0.005 mΩ/cm², 0.006 mΩ/cm², 0.007 mΩ/cm², or 0.008 mΩ/cm², or falls within a range defined by any two of these values. The adaption of the negative electrode plate with suitable surface resistance can more effectively reduce the gas generated at a negative electrode interface at high temperatures, thereby improving the cycling performance of the secondary battery at high temperatures.

In some embodiments of this application, the negative electrode plate includes a negative electrode current collector and a negative electrode material layer provided on at least one surface of the negative electrode current collector. The negative electrode material layer includes a negative electrode active material, a conductive agent, a thickener, and a binder. Typically, the surface resistance R of the negative electrode plate can be controlled by controlling types and amounts of the negative electrode active material, the conductive agent, and the binder.

The negative electrode active material is not particularly limited in this application, provided that the objectives of this application can be achieved. For example, the negative electrode active material may include but is not limited to at least one of natural graphite, artificial graphite, mesocarbon microbeads, hard carbon, soft carbon, silicon, silicon-carbon composite, Li—Sn alloy, Li—Sn—O alloy, Sn, SnO, SnO₂, spinel-structured lithiated TiO₂—Li₄Ti₅O₁₂, or Li—Al alloy.

Types of the conductive agent and the binder are not particularly limited in this application, provided that the objectives of this application can be achieved. For example, the conductive agent may include but is not limited to at least one of conductive carbon black (Super P), carbon nanotubes (CNTs), carbon fiber, flake graphite, graphene, a metal material, or a conductive polymer. The conductive carbon black may include but is not limited to at least one of acetylene black or Ketjen black. The carbon nanotubes may include but are not limited to single-walled carbon nanotubes and/or multi-walled carbon nanotubes. The carbon fiber may include but is not limited to vapor grown carbon fiber (VGCF) and/or carbon nanofiber. The metal material may include but is not limited to metal powder and/or metal fiber. Specifically, the metal may include but is not limited to at least one of copper, nickel, aluminum, or silver. The conductive polymer may include but is not limited to at least one of a polyphenylene derivative, polyaniline, polythiophene, polyacetylene, or polypyrrole. For example, the binder may include but is not limited to at least one of polyacrylic acid, sodium polyacrylate, potassium polyacrylate, lithium polyacrylate, polyimide, polyvinyl alcohol, sodium carboxymethyl cellulose, lithium carboxymethyl cellulose, polyimide, polyamideimide, styrene-butadiene rubber, or poly(vinylidene difluoride). Type of the thickener is not particularly limited in this application, provided that the objectives of this application can be achieved. For example, the thickener may include but is not limited to carboxymethyl cellulose.

In this application, a mass ratio of the negative electrode active material, conductive agent, thickener, and binder in the negative electrode material layer may be (80 to 99):(0.5 to 8):(0 to 2):(0.5 to 8).

The above “a negative electrode material layer provided on at least one surface of the negative electrode current collector” means that the negative electrode material layer may be provided on one surface of the negative electrode current collector in its thickness direction or on both surfaces of the negative electrode current collector in its thickness direction. It should be noted that the “surface” herein may be an entire region of the surface of the negative electrode current collector or a partial region of the surface of the negative electrode current collector. This is not particularly limited in this application, provided that the objectives of this application can be achieved.

The negative electrode current collector is not particularly limited in this application, provided that the objectives of this application can be achieved. For example, the negative electrode current collector may include a copper foil, a copper alloy foil, a nickel foil, a stainless steel foil, a titanium foil, nickel foam, copper foam, or a composite current collector. For example, the composite current collector may be a lithium-copper composite current collector, a carbon-copper composite current collector, a nickel-copper composite current collector, or a titanium-copper composite current collector.

Thickness of the negative electrode material layer is not particularly limited in this application, provided that the objectives of this application can be achieved. For example, the thickness of a single negative electrode material layer is 30 μm to 120 μm. Thickness of the negative electrode current collector is not particularly limited in this application, provided that the objectives of this application can be achieved. For example, the thickness of the negative electrode current collector is 4 μm to 15 μm.

In this application, the positive electrode plate includes a positive electrode current collector and a positive electrode material layer provided on at least one surface of the positive electrode current collector. The above “a positive electrode material layer provided on at least one surface of the positive electrode current collector” means that the positive electrode material layer may be provided on one surface of the positive electrode current collector in its thickness direction or on both surfaces of the positive electrode current collector in its thickness direction. It should be noted that the “surface” herein may be an entire region of the surface of the positive electrode current collector or a partial region of the surface of the positive electrode current collector. This is not particularly limited in this application, provided that the objectives of this application can be achieved.

The positive electrode current collector is not particularly limited in this application, provided that the objectives of this application can be achieved. For example, the positive electrode current collector may include an aluminum foil, an aluminum alloy foil, a composite current collector (for example, an aluminum-carbon composite current collector), and the like.

The positive electrode material layer includes a positive electrode active material, and the positive electrode active material is not particularly limited in this application, provided that the objectives of this application can be achieved. For example, the positive electrode active material may include at least one of lithium nickel cobalt manganate (for example, NCM811, NCM622, NCM523, and NCM111), lithium nickel cobalt aluminate, lithium iron phosphate, a lithium-rich manganese-based material, lithium cobalt oxide (LiCoO₂), lithium manganate, lithium manganese iron phosphate, or lithium titanate.

The positive electrode material layer may further include a conductive agent and a binder. Types of the conductive agent and the binder are not particularly limited in this application, provided that the objectives of this application can be achieved. For example, the conductive agent and the binder may be at least one of the foregoing conductive agents and the foregoing binders. A mass ratio of the positive electrode active material, conductive agent, and binder in the positive electrode material layer is not particularly limited in this application, and can be selected by persons skilled in the art based on actual needs, provided that the objectives of this application can be achieved.

Thicknesses of the positive electrode current collector and the positive electrode material layer are not particularly limited in this application, provided that the objectives of this application can be achieved. For example, the thickness of the positive electrode current collector is 5 μm to 20 μm, and the thickness of a single positive electrode material layer is 30 μm to 120 μm.

Optionally, the positive electrode plate may further include a conductive layer, and the conductive layer is located between the positive electrode current collector and the positive electrode material layer. Composition of the conductive layer is not particularly limited, and the conductive layer may be a conductive layer commonly used in the art. The conductive layer includes a conductive agent and a binder. The conductive agent and binder in the conductive layer are not particularly limited in this application, and may be, for example, at least one of the foregoing conductive agents and the foregoing binders.

In this application, the secondary battery further includes a housing for accommodating the positive electrode plate, the separator, the negative electrode plate, and the electrolyte, as well as other components known in the field of secondary batteries. The above other components are not particularly limited in this application. The housing is not particularly limited in this application and may be a housing well-known in the art, provided that the objectives of this application can be achieved. For example, the housing may be a hard housing or a flexible housing. The material of the hard housing may be metal. Type of the metal is not limited in this application. The hard housing may use a metal hard housing known in the art, provided that the objectives of this application can be achieved. The flexible housing may be a metal-plastic film, for example, an aluminum-plastic film or a steel-plastic film.

A preparation process of the secondary battery in this application is well known to persons skilled in the art and is not particularly limited in this application. For example, the preparation process of the secondary battery may include but is not limited to the following steps: The positive electrode plate, the separator, and the negative electrode plate are stacked sequentially. The resulting stack is subjected to operations such as winding or folding based on the needs to obtain an electrode assembly with a wound structure. Then, the electrode assembly is placed into the housing, the electrolyte is injected into the housing, and sealing is performed to obtain the secondary battery. Alternatively, the positive electrode plate, the separator, and the negative electrode plate are stacked sequentially, and then four corners of an entire laminated structure are fastened by an adhesive tape to obtain an electrode assembly with the laminated structure. Then, the electrode assembly is placed into the housing, the electrolyte is injected into the housing, and sealing is performed to obtain the secondary battery. In addition, an overcurrent prevention element, a guide plate, and the like may also be placed in the housing based on the needs, so as to prevent pressure increase, overcharge, and overdischarge in the secondary battery.

A third aspect of this application provides an electronic apparatus including the secondary battery according to any one of the foregoing embodiments. Therefore, the electronic apparatus provided in this application has good use performance.

Type of the electronic apparatus is not particularly limited in this application, and the electronic apparatus may be any known electronic apparatus used in the prior art. In some embodiments of this application, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, and a lithium-ion capacitor.

### EXAMPLES

The following describes some embodiments of this application more specifically by using examples and comparative examples. Various tests and evaluations are performed in the following methods. In addition, unless otherwise specified, “part” and “%” are based on weight.

### Test Methods and Devices

### Test for Capacity Retention Rate after 400 Cycles at −15° C.

The lithium-ion battery in each of examples and comparative examples was repeatedly charged and discharged in the following steps, and a discharge capacity retention rate of the lithium-ion battery was calculated.

At −15° C., the lithium-ion battery was charged and discharged for the first time. The lithium-ion battery was constant-current charged to a full-charge voltage of 3.8 V at a charge current of 2 C, then constant-voltage charged to a current of 0.02 C at the full-charge voltage, and then constant-current discharged to a final voltage of 2.8 V at a discharge current of 0.5 C. This was one charge and discharge cycle, and a discharge capacity at the first cycle was recorded. Then, the above steps were repeated to perform 400 charge and discharge cycles, and a discharge capacity at the 400th cycle was recorded.

Cycling capacity retention rate=(discharge capacity at the 400th cycle/discharge capacity at the first cycle)×100%, which was denoted as “intermittent cycling capacity retention rate after 400 cycles at −15° C.”.

### Drop Test at 55° C.

The lithium-ion battery was fixed in a drop test fixture with a double-sided adhesive tape, where six surfaces of the fixture were sequentially numbered as 1, 2, 3, 4, 5, and 6, and four corners of the fixture were sequentially numbered as C1, C2, C3, and C4.

At 55° C., the fixture was placed on a test bench with a height of 1.5 m, the lithium-ion battery was sequentially dropped according to the order of the numbers 1 to 6, and then the lithium-ion battery was sequentially dropped according to the order of the numbers C1 to C4. This was one cycle. The above steps were repeated for six cycles to complete the drop test. After the lithium-ion battery was left standing for 1 h, observation was made to see whether a packaging shell of the lithium-ion battery was damaged or a top seal was pushed open, and whether the following cases existed.

A. The lithium-ion battery was disassembled to observe whether tabs in the electrode assembly were broken.

B. The lithium-ion battery was disassembled to observe whether separators on both sides of the electrode assembly in a width direction were displaced or wrinkled.

C. The lithium-ion battery was disassembled to observe whether the positive electrode plate and the negative electrode plate were internally short-circuited due to the contact therebetween.

If none of the above cases occurred, the lithium-ion battery was considered to pass the test. 15 lithium-ion batteries in each group were tested, and the number of lithium-ion batteries that passed the drop test was recorded.

### Test for Capacity Retention Rate at the 120th Cycle in Intermittent Cycling Test at 40° C.

At 40° C., the lithium-ion battery was left standing for 30 minutes, constant-current charged to a full-charge voltage of 3.8 V at a rate of 0.5 C, and then constant-voltage charged to 0.05 C at the full-charge voltage. Then, the lithium-ion battery was left standing at 40° C. for 20 hours. Then, the lithium-ion battery was constant-current discharged to 3.0 V at a rate of 0.5 C, and a discharge capacity of the battery was recorded. This was a complete intermittent charge and discharge cycle. The lithium-ion battery was subjected to 120 charge and discharge cycles in the same method.

Capacity retention rate at the 120th cycle of lithium-ion battery (%)=discharge capacity at the 90th cycle/discharge capacity at the first cycle×100%, which was denoted as “intermittent cycling capacity retention rate at the 120th cycle at 40° C.”.

### Test for Thickness Swelling Rate after 500 Cycles at 50° C.

The lithium-ion battery in each of examples and comparative examples was repeatedly charged and discharged in the following steps, and a discharge capacity retention rate of the lithium-ion battery was calculated.

At 50° C., the lithium-ion battery was charged and discharged for the first time. The lithium-ion battery was constant-current charged to a full-charge voltage of 3.8 V at a charge current of 2 C, then constant-voltage charged to a current of 0.02 C at the full-charge voltage, and then constant-current discharged to a final voltage of 3.0 V at a discharge current of 0.5 C. This was one charge and discharge cycle, and a thickness H1 of the battery at the first cycle was recorded. Then, the above steps were repeated to perform 500 charge and discharge cycles, and a thickness H2 of the battery at the 500th cycle was recorded.

Thickness swelling rate=(H2−H1)/H1×100%, which was denoted as “thickness swelling rate after 500 cycles at 50° C.”.

### Test for Charge and Discharge Performance at 40° C.

The lithium-ion battery in each of examples and comparative examples was repeatedly charged and discharged in the following steps, and a discharge capacity retention rate of the lithium-ion battery was calculated.

At 40° C., the lithium-ion battery was charged and discharged for the first time. The lithium-ion battery was constant-current charged to a full-charge voltage of 3.8 V at a charge current of 2 C, then constant-voltage charged to a current of 0.02 C at the full-charge voltage, and then constant-current discharged to a final voltage of 3.0 V at a discharge current of 0.5 C. This was one charge and discharge cycle, and a discharge capacity at the first cycle was recorded. Then, the above steps were repeated to perform 500 charge and discharge cycles, and a discharge capacity at the 500th cycle was recorded.

Cycling capacity retention rate=(discharge capacity at the 500th cycle/discharge capacity at the first cycle)×100%, which was denoted as “capacity retention rate after 500 cycles at 40° C.”.

### Test for Amount of Gas Generated at 60° C.

At 60° C., the lithium-ion battery was constant-current charged to a full-charge voltage of 3.8 V at a current of 0.3 C, and then constant-voltage charged for 1 h to a current of 0.02 C at the full-charge voltage. Then, the charged lithium-ion battery was stored in a thermostatic bath at 60° C. After stored for 200 hours, the lithium-ion battery was taken out of the thermostatic bath. After the temperature returned to the room temperature, the amount of gas generated in the lithium-ion battery was measured. The storage characteristics of the battery were evaluated in this method. The amount of gas generated was measured using an in-situ gas generation measurement apparatus.

### Porosity Test

A density of the separator was similar to that of an equivalent non-porous film, so that the effect caused by the density was ignored when the porosity was calculated. The mass of the separator and the mass of the equivalent non-porous film were tested, and the porosity was calculated according to the following formula:

porosity (%)=(w2−w1)/w2×100%,
where w1 represented the mass of the separator, and w2 represented the mass of the equivalent non-porous film. The equivalent non-porous film referred to a film with the same length, width, and thickness as the separator and without a porous structure, and the composition of the film was the same as the polyethylene base film.

### Test for Surface Resistance of Negative Electrode Plate

A Hioki resistance tester was used to test the resistance of the negative electrode plate, three positions were randomly selected for measurement, and an average value was taken as a final test result.

### Test for Area Percentage A

The separator was placed in an oven at 110° C. for 30 min, and then the separator was placed on a piece of transparent grid coordinate plastic paper. A region not covered by the molten coating was marked, and an area of the region was denoted as S1. Then, an area of the separator was denoted as S0. The area percentage A was equal to S1/S0×100%.

### Test for Melt Flow Rate

A melt flow rate tester was used to test a melt flow rate of a material. An instrument was heated to 110° C., and a standard die with a diameter of φ2.095±0.005 mm was placed into the instrument; the material was placed into a barrel and compacted; the temperature was maintained for 10 min; a material cutting time was 60 s, the material was extruded under a pressure of 2.16 kg, and calculation was performed to obtain the melt flow rate MFR of the material. MFR=mT/t, where t was the cutting time of 60 s, m was the mass of the material, and T was 600 seconds.

### Test for Pore Closing Temperature of Separator

The pore closing temperature of the separator was tested using a temperature rise internal resistance method. First, the separator was cut into a fixed size of 5 cm×5 cm, and the size of the separator was larger than the size of a test region of the fixture. The separator was placed in a component composed of ceramic and stainless steel fixtures, and 10 mL electrolyte was injected. The fixture was placed in an oven, and the temperature of the oven was set to be 250° C. and increased at a specified speed of 15° C./min. The resistance and temperature of the fixture were monitored, and data of the temperature and resistance of the fixture, the temperature of the oven, and time were output to obtain a temperature-resistance curve. According to the temperature-resistance curve, a temperature at which the resistance suddenly increased to 1000 Ω was a pore closing temperature T1 of the separator.

### Test for Pore Closing Temperature of Polyethylene Base Film

The polyethylene base film was cut into a fixed size of 5 cm×5 cm and then placed in a component composed of ceramic and stainless steel fixtures, and 10 mL electrolyte was injected. The fixture was placed in an oven at 250° C., and the temperature of the oven increased at a specified speed of 15° C./min. The resistance and temperature of the fixture were monitored, and data of the resistance and temperature of the fixture, the temperature of the oven, and time were output to obtain a time-resistance curve.

According to the time-resistance curve, a temperature at which the resistance suddenly increased to 1000 Ω was a pore closing temperature T2 of the base film.

### Example 1-1

### Preparation of Positive Electrode Plate

A positive electrode active material lithium iron phosphate, a conductive agent acetylene black, and a binder poly (vinylidene difluoride) were mixed at a mass ratio of 85:7:8; N-methylpyrrolidone (NMP) was added as a solvent; and the resulting mixture was prepared into a slurry with a solid content of 75 wt %. The slurry was well stirred under vacuum to obtain a positive electrode slurry. The positive electrode slurry was uniformly applied on one surface of a positive electrode current collector aluminum foil with a thickness of 10 μm, and drying was performed at 120° C. to obtain a positive electrode plate with a positive electrode material layer applied on one surface, where a coating weight of the positive electrode material layer is 267.8 mg/1540 mm². Then, the above steps were repeated on another surface of the aluminum foil to obtain a positive electrode plate with positive electrode material layers applied on both surfaces. The positive electrode plate was dried at 120° C. and then cold pressed, followed by cutting and tab welding, to obtain a positive electrode plate with a size of 74 mm×867 mm for later use. The thickness of the positive electrode material layer on one surface was 42 μm.

### Preparation of Negative Electrode Plate

Negative electrode active materials artificial graphite and SiC, a conductive agent carbon black, a thickener carboxymethyl cellulose, and a binder polyvinyl alcohol were mixed at a mass ratio A of 93:4:0.8:1.1:1.1, and NMP and deionized water were added as solvents, where a mass ratio of NMP to deionized water was 3:110; and the resulting mixture was prepared into a slurry with a solid content of 45 wt %. The slurry was well stirred in a vacuum mixer to obtain a negative electrode slurry. The negative electrode slurry was uniformly applied on one surface of a negative electrode current collector copper foil with a thickness of 6 μm, and drying was performed at 120° C. to obtain a negative electrode plate with a negative electrode material layer applied on one surface, where a coating weight of the negative electrode material layer is 142 mg/1540 mm². Then, the above steps were repeated on another surface of the copper foil to obtain a negative electrode plate with negative electrode material layers applied on both surfaces. The negative electrode plate was dried at 120° C. and then cold pressed, followed by cutting and tab welding, to obtain a negative electrode plate with a size of 78 mm×875 mm for later use. The thickness of the negative electrode material layer on one surface was 54.5 μm.

### Preparation of Electrolyte

In an environment with a water content of less than 10 ppm, ethylene carbonate, propylene carbonate, and diethyl carbonate were mixed at a mass ratio of 1:3:1 to obtain an organic solvent, and then a lithium salt LiPF₆ was added into the organic solvent. Then, the resulting solution was mixed well to obtain an electrolyte. Based on a mass of the electrolyte, a mass percentage of the lithium salt was 12.5%, and the rest was the organic solvent.

### Preparation of Separator

A polyethylene (PE) microporous film with a thickness of 7 μm was used as a polyethylene base film.

A first material polypropylene, a second material polypropylene, sodium carboxymethyl cellulose, and dimethylsiloxane were mixed at a mass ratio of 47.5:47.5:0.7:4.3, and deionized water was added. The resulting mixture was prepared into a coating slurry with a viscosity of 38 mPa·s and a solid content of 5 wt %. The coating slurry was applied on one surface of the polyethylene base film, and drying was performed at 120° C. to obtain a separator with a coating applied on one surface, where a coating weight of the coating was 1.5 mg/5000 mm², and a thickness of the coating on one surface was 3 μm. A melt flow rate MFR1 of the first material was 8 g/10 min, and a melt flow rate MFR2 of the second material was 1 g/10 min.

### Preparation of Lithium-Ion Battery

The prepared positive electrode plate, separator, and negative electrode plate were stacked sequentially, so that the separator was located between the positive electrode plate and the negative electrode plate to provide separation. Then, the resulting stack was wound to obtain an electrode assembly. The coating of the separator faced the positive electrode plate. The electrode assembly was placed into an aluminum-plastic film packaging bag and was dehydrated at 80° C. Then, the prepared electrolyte was injected. Processes such as vacuum sealing, standing, formation, degassing, and trimming were performed to obtain a lithium-ion battery. An upper limit voltage during formation was 4.15 V, a formation temperature was 70° C., and the formation standing time was 2 h.

### Examples 1-2 to 1-21

These examples were the same as Example 1-1 except that the related preparation parameters were adjusted according to Table 1. When the mass ratio X of the first material to the second material changed, the total mass of the first and second materials remained unchanged.

### Examples 2-1 to 2-24

These examples were the same as Example 1-1, except that ethylene sulfate, vinylene sulfate, the nitrile compound butanedinitrile, and the fluorine compound fluoroethylene carbonate were also added in <preparation of electrolyte> according to Table 2, and the related preparation parameters were adjusted according to Table 2. When at least one of the mass percentage W1 of ethylene sulfate, the mass percentage W2 of vinylene sulfate, the mass percentage W3 of the nitrile compound, and the mass percentage W4 of the fluorine compound changed, the amount of the organic solvent changed accordingly.

### Examples 3-1 to 3-10

These examples were the same as Example 1-1, except that 3-(diphenylphosphino)benzenesulfonate lithium was also added in <preparation of electrolyte>, and the related preparation parameters were adjusted according to Table 3. When the mass percentage W5 of 3-(diphenylphosphino)benzenesulfonate lithium changed, the amount of the organic solvent changed accordingly.

### Examples 3-11 to 3-13

These examples were the same as Examples 2-19, 2-20, and 2-3 sequentially except that 3-(diphenylphosphino)benzenesulfonate lithium was also added in <preparation of electrolyte>, and the related preparation parameters were adjusted according to Table 3. When the mass percentage W5 of 3-(diphenylphosphino)benzenesulfonate lithium changed, the amount of the organic solvent changed accordingly.

### Comparative Examples 1 to 3

These comparative examples were the same as Example 1-1 except that the related preparation parameters were adjusted according to Table 1.

Preparation parameters and performance tests of examples and comparative examples are shown in Tables 1 to 3.

TABLE 1

| | | | | | | | | | | | | Intermittent |
|---|---|---|---|---|---|---|---|---|---|---|---|---|
| | | | | | | | | | | | | cycling |
| | | | | | | | | | | | | capacity |
| | | | | | | | | | | | | retention |
| | | | Mass | MFR1 | MFR2 | | | | | Area | Drop test | rate at the |
| | First | Second | ratio | (g/10 | (g/10 | T1 | T2 | T2-T1 | P | percentage | pass rate | 120th cycle |
| | material | material | X | min) | min) | (° C.) | (° C.) | (° C.) | (%) | A | (%) | at 40° C. |
| Example 1-1 | Polyethylene | Polypropylene | 1:1 | 8 | 1 | 137 | 146 | 9 | 25 | 79 | 14/15 | 72.4 |
| Example 1-2 | Polyethylene | Polypropylene | 1:1 | 10 | 1 | 136 | 146 | 10 | 27 | 77 | 15/15 | 74.2 |
| Example 1-3 | Polyethylene | Polypropylene | 1:1 | 12 | 1 | 133 | 146 | 13 | 23 | 72 | 15/15 | 73.2 |
| Example 1-4 | Polyethylene | Polypropylene | 1:1 | 17 | 1 | 135 | 146 | 11 | 24 | 74 | 13/15 | 71.6 |
| Example 1-5 | Polyethylene | Polypropylene | 1:1 | 6 | 1 | 140 | 146 | 6 | 24 | 83 | 12/15 | 70.5 |
| Example 1-6 | Polyethylene | Polypropylene | 1:1 | 20 | 1 | 127 | 146 | 19 | 13 | 72 | 13/15 | 70.9 |
| Example 1-7 | Polyethylene | Polypropylene | 1:1 | 10 | 0.5 | 140 | 146 | 6 | 44 | 82 | 14/15 | 71.9 |
| Example 1-8 | Polyethylene | Polypropylene | 1:1 | 10 | 0.7 | 140 | 146 | 6 | 45 | 81 | 14/15 | 72.6 |
| Example 1-9 | Polyethylene | Polypropylene | 1:1 | 10 | 1 | 139 | 146 | 7 | 55 | 85 | 13/15 | 70.8 |
| Example 1-10 | Polyethylene | Polypropylene | 1:1 | 10 | 1.5 | 133 | 146 | 13 | 24 | 74 | 13/15 | 71.3 |
| Example 1-11 | Polyethylene | Polypropylene | 1:1 | 10 | 2.5 | 131 | 146 | 15 | 14 | 76 | 13/15 | 71.6 |
| Example 1-12 | Polyethylene | Polypropylene | 1:1 | 10 | 2.7 | 129 | 146 | 17 | 15 | 78 | 11/15 | 71.1 |
| Example 1-13 | Polyethylene | Polypropylene | 1:1 | 10 | 0.3 | 141 | 146 | 5 | 43 | 75 | 11/15 | 70.7 |
| Example 1-14 | Polyethylene | Polypropylene | 1:1 | 12 | 1 | 133 | 136 | 3 | 40 | 73 | 12/15 | 70.6 |
| Example 1-15 | Polyethylene | Polypropylene | 1:1 | 12 | 1 | 133 | 140 | | 19 | 72 | 13/15 | 70.5 |
| Example 1-16 | Polyethylene | Polypropylene | 1:1 | 12 | 1 | 133 | 143 | 10 | 22 | 75 | 14/15 | 72.6 |
| Example 1-17 | Polyethylene | Polypropylene | 1:1 | 10 | 1 | 133 | 146 | 13 | 24 | 74 | 14/15 | 71.3 |
| Example 1-18 | Polyethylene | Polypropylene | 1:4.5 | 10 | 1 | 133 | 146 | 13 | 25 | 76 | 14/15 | 71.7 |
| Example 1-19 | Polyethylene | Polypropylene | 1:0.5 | 10 | 1 | 133 | 146 | 13 | 23 | 73 | 11/15 | 70.6 |
| Example 1-20 | Polyethylene | Polypropylene | 1:5 | 10 | 1 | 133 | 146 | 13 | 26 | 76 | 11/15 | 70.8 |
| Example 1-21 | Polyvinylidene | Polyacrylic acid | 1:1 | 10 | 1 | 135 | 146 | 11 | 22 | 74 | 12/15 | 70.4 |
| | fluoride | | | | | | | | | | | |
| Comparative | Polyethylene | Polypropylene | 1:1 | 12 | 3 | 127 | 146 | 19 | 48 | 71 | 7/15 | 62.4 |
| example 1 | | | | | | | | | | | | |
| Comparative | Polyethylene | Polypropylene | 1:1 | 12 | 0.4 | 144 | 146 | 2 | 13 | 87 | 4/15 | 60.5 |
| example 2 | | | | | | | | | | | | |
| Comparative | Polyethylene | Polypropylene | 1:1 | 19 | 1 | 128 | 146 | 18 | 20 | 66 | 5/15 | 65.4 |
| example 3 | | | | | | | | | | | | |

It can be seen from Example 1-1 to Example 1-21 and Comparative examples 1 to 3 that when T2−T1 and the porosity P both fall within the ranges in this application, the obtained lithium-ion battery has a higher drop test pass rate at 55° C. and capacity retention rate at the 120th cycle in intermittent cycling test at 40° C. This indicates that the drop performance and intermittent cycling performance of the lithium-ion battery at high temperatures are improved.

The types and melt flow rates of the first material and second material in the coating as well the mass ratio X of the two affect the area percentage A and the pore closing temperature T1 of the separator, thereby affecting the drop performance and intermittent cycling performance of the secondary battery. It can be seen from Example 1-1 to Example 1-21 that when the types and melt flow rates of the first material and second material in the coating as well the mass ratio X of the two fall within the ranges in this application, the obtained lithium-ion battery has a high drop test pass rate at 55° C. and capacity retention rate at the 120th cycle in intermittent cycling test at 40° C. This indicates that the lithium-ion battery has good drop performance and intermittent cycling performance at high temperatures.

TABLE 2

| | | | | | | | | Intermittent | Thickness | Intermittent |
|---|---|---|---|---|---|---|---|---|---|---|
| | | | | | | | | cycling capacity | swelling rate | cycling capacity |
| | | | | | | | | retention rate at | after 500 | retention rate |
| | | | | | | | Drop test | the 120th cycle | cycles at 50° C. | after 400 cycles |
| | W1 (%) | W2 (%) | W1/W2 | W3 (%) | W4 (%) | W3/W4 | pass rate | at 40° C. (%) | (%) | at −15° C. (%) |
| Example 1-1 | / | / | / | / | / | / | 14/15 | 72.4 | 2.87 | 72.3 |
| Example 2-1 | 0.4 | 1.3 | 0.30 | 1.2 | 4.20 | 0.29 | 15/15 | 73.6 | 2.76 | 73.3 |
| Example 2-2 | 0.5 | 0.8 | 0.60 | 1.2 | 4.20 | 0.29 | 15/15 | 73.8 | 2.73 | 73.6 |
| Example 2-3 | 0.7 | 1.0 | 0.70 | 1.2 | 4.20 | 0.29 | 15/15 | 73.6 | 2.75 | 73.4 |
| Example 2-4 | 0.8 | 0.8 | 1.00 | 1.2 | 4.20 | 0.29 | 15/15 | 74.1 | 2.72 | 73.2 |
| Example 2-5 | 0.95 | 0.6 | 1.50 | 1.2 | 4.20 | 0.29 | 15/15 | 74.3 | 2.64 | 74.1 |
| Example 2-6 | 1 | 0.5 | 2.00 | 1.2 | 4.20 | 0.29 | 15/15 | 74.2 | 2.68 | 74.0 |
| Example 2-7 | 0.7 | 1.0 | 0.70 | 1.2 | 3.60 | 0.33 | 14/15 | 74.0 | 2.75 | 73.8 |
| Example 2-8 | 0.7 | 1.0 | 0.70 | 1.2 | 3.00 | 0.40 | 15/15 | 74.2 | 2.71 | 74.5 |
| Example 2-9 | 0.7 | 1.0 | 0.70 | 1.2 | 2.40 | 0.50 | 15/15 | 73.9 | 2.73 | 74.7 |
| Example 2-10 | 0.7 | 1.0 | 0.70 | 1.2 | 1.80 | 0.67 | 15/15 | 73.4 | 2.76 | 73.9 |
| Example 2-11 | 0.7 | 1.0 | 0.70 | 1.2 | 1.20 | 1.00 | 15/15 | 73.5 | 2.78 | 73.3 |
| Example 2-12 | 0.7 | 1.0 | 0.70 | 1.2 | 0.60 | 2.00 | 14/15 | 73.7 | 2.75 | 73.1 |
| Example 2-13 | 0.1 | 0.3 | 0.30 | 1.2 | 0.60 | 2.00 | 12/15 | 73.5 | 3.21 | 70.1 |
| Example 2-14 | 1.2 | 4.0 | 0.30 | 1.2 | 0.60 | 2.00 | 13/15 | 73.8 | 3.15 | 72.5 |
| Example 2-15 | 0.4 | 5.7 | 0.07 | 1.2 | 0.60 | 2.00 | 13/15 | 73.7 | 3.17 | 72.3 |
| Example 2-16 | 0.4 | 0.2 | 2.20 | 1.2 | 0.60 | 2.00 | 12/15 | 73.7 | 3.18 | 72.1 |
| Example 2-17 | 0.4 | 1.3 | 0.30 | 1.2 | 8.40 | 0.14 | 13/15 | 73.5 | 3.11 | 72.4 |
| Example 2-18 | 0.4 | 1.3 | 0.30 | 1.2 | 0.57 | 2.10 | 14/15 | 73.8 | 3.05 | 72.6 |
| Example 2-19 | 0.7 | 1.0 | 0.70 | / | / | / | 14/15 | 73.1 | 2.84 | 72.6 |
| Example 2-20 | / | / | / | 1.2 | 1.80 | 0.67 | 15/15 | 73.2 | 2.82 | 72.9 |
| Example 2-21 | / | / | / | 0.5 | 1.8 | 0.28 | 15/15 | 73.1 | 2.79 | 73.5 |
| Example 2-22 | / | / | / | 3 | 1.8 | 1.67 | 15/15 | 73.6 | 2.73 | 74.1 |
| Example 2-23 | / | / | / | 4.5 | 2.4 | 1.88 | 15/15 | 73.0 | 2.79 | 73.5 |
| Example 2-24 | / | / | / | 5.5 | 2.4 | 2.29 | 13/15 | 73.5 | 2.86 | 72.7 |

Note:
“/” in Table 2 indicates that there are no related preparation parameters.

It can be seen from Example 1-1 and Examples 2-2 to 2-18 that when ethylene sulfate, vinylene sulfate, the nitrile compound, and the fluorine compound are added into the electrolyte, the obtained lithium-ion battery has a higher drop test pass rate at 55° C., capacity retention rate at the 120th cycle in intermittent cycling test at 40° C., and capacity retention rate after 400 cycles at −15° C. as well as a lower thickness swelling rate after 500 cycles at 50° C. This indicates that when ethylene sulfate, vinylene sulfate, the nitrile compound, and the fluorine compound are added into the electrolyte, the drop performance, intermittent cycling performance, cycling performance, and low-temperature cycling performance of the lithium-ion battery at high temperatures are improved.

It can be seen from Examples 2-1 to 2-6 and Examples 2-13 to 2-16 that when the mass percentage W1 of ethylene sulfate, the mass percentage W2 of vinylene sulfate, and W1/W2 fall within the ranges in this application, the obtained lithium-ion battery has a higher drop test pass rate at 55° C., capacity retention rate at the 120th cycle in intermittent cycling test at 40° C., and capacity retention rate after 400 cycles at −15° C. as well as a lower thickness swelling rate after 500 cycles at 50° C. This indicates that the drop performance, intermittent cycling performance, storage performance, and low-temperature cycling performance of the lithium-ion battery at high temperatures are improved.

It can be seen from Example 2-1, Examples 2-7 to 2-12, and Examples 2-17 and 2-18 that when the mass percentage W3 of the nitrile compound, the mass percentage W4 of the fluorine compound, and W3/W4 fall within the ranges in this application, the obtained lithium-ion battery has a higher drop test pass rate at 55° C., capacity retention rate at the 120th cycle in intermittent cycling test at 40° C., and capacity retention rate after 400 cycles at −15° C. as well as a lower thickness swelling rate after 500 cycles at 50° C. This indicates that the drop performance, intermittent cycling performance, storage performance, and low-temperature cycling performance of the lithium-ion battery at high temperatures are improved.

It can be seen from Example 1-1 and Example 2-19 that when ethylene sulfate and vinylene sulfate are added into the electrolyte, the obtained lithium-ion battery has a higher drop test pass rate at 55° C., capacity retention rate at the 120th cycle in intermittent cycling test at 40° C., and capacity retention rate after 400 cycles at-15° C. as well as a lower thickness swelling rate after 500 cycles at 50° C. This indicates that when ethylene sulfate and vinylene sulfate are added into the electrolyte, the drop performance, intermittent cycling performance, cycling performance, and low-temperature cycling performance of the lithium-ion battery at high temperatures are improved.

It can be seen from Example 1-1 and Examples 2-20 to 2-24 that when the nitrile compound and the fluorine compound are added into the electrolyte, the obtained lithium-ion battery has a higher drop test pass rate at 55° C., capacity retention rate at the 120th cycle in intermittent cycling test at 40° C., and capacity retention rate after 400 cycles at −15° C. as well as a lower thickness swelling rate after 500 cycles at 50° C. This indicates that the nitrile compound and the fluorine compound are added into the electrolyte, the drop performance, intermittent cycling performance, cycling performance, and low-temperature cycling performance of the lithium-ion battery at high temperatures are improved.

TABLE 3

| | | | Surface | | | | |
|---|---|---|---|---|---|---|---|
| | | | resistance of | | Intermittent cycling | | Capacity |
| | | | negative | | capacity retention | Generation | retention rate |
| | | | electrode plate | Drop test pass | rete at the 120th | amount at | after 500 cycles |
| | W5 (%) | Mass ratio A | (mΩ/cm²) | rate | cycle at 40° C. (%) | 60° C. (mL) | at 40° C. (%) |
| Example 1-1 | / | 93:4:0.8:1.1:1.1 | 0.002 | 14/15 | 72.4 | 0.40 | 74.2 |
| Example 3-1 | 1 | 93:4:0.8:1.1:1.1 | 0.002 | 14/15 | 73.1 | 0.32 | 75.6 |
| Example 3-2 | 2 | 93:4:0.8:1.1:1.1 | 0.002 | 14/15 | 73.50 | 0.30 | 76.10 |
| Example 3-3 | 3 | 93:4:0.8:1.1:1.1 | 0.002 | 15/15 | 73.70 | 0.28 | 76.30 |
| Example 3-4 | 4 | 93:4:0.8:1.1:1.1 | 0.002 | 15/15 | 73.80 | 0.25 | 76.40 |
| Example 3-5 | 0.60 | 93:4:0.8:1.1:1.1 | 0.002 | 14/15 | 73.50 | 0.35 | 74.10 |
| Example 3-6 | 4.50 | 93:4:0.8:1.1:1.1 | 0.002 | 14/15 | 73.30 | 0.34 | 75.30 |
| Example 3-7 | 3 | 93.5:3.5:0.8:1.1:1.1 | 0.004 | 14/15 | 73.50 | 0.29 | 76.50 |
| Example 3-8 | 3 | 93.7:3.3:0.6:1.2:1.2 | 0.006 | 14/15 | 73.50 | 0.30 | 76.70 |
| Example 3-9 | 3 | 94:3:0.6:1.2:1.2 | 0.008 | 14/15 | 73.40 | 0.33 | 74.30 |
| Example 3-10 | 3 | 94:3:0.3:1.5:1.2 | 0.01 | 13/15 | 73.20 | 0.36 | 74.80 |
| Example 3-11 | 3 | 93:4:0.8:1.1:1.1 | 0.002 | 15/15 | 74.0 | 0.24 | 76.7 |
| Example 3-12 | 3 | 93:4:0.8:1.1:1.1 | 0.002 | 15/15 | 74.1 | 0.23 | 76.8 |
| Exonaple 3-13 | 3 | 93:4:0.8:1.1:1.1 | 0.002 | 15/15 | 74.6 | 0.20 | 77.1 |

Note:
“/” in Table 3 indicates that there are no related preparation parameters.

It can be seen from Example 1-1 and Examples 3-1 to 3-6 that when 3-(diphenylphosphino)benzenesulfonate lithium is added into the electrolyte, the obtained lithium-ion battery has a higher drop test pass rate at 55° C., capacity retention rate at the 90th cycle in intermittent cycling test at 40° C., and capacity retention rate after 500 cycles at 40° C. as well as a smaller amount of gas generated at 60° C. This indicates that the drop performance, intermittent cycling performance, and cycling performance of the lithium-ion battery at high temperatures are improved.

It can be seen from Examples 3-1 to 3-6 that when the mass percentage W5 of 3-(diphenylphosphino)benzenesulfonate lithium falls within the range in this application, the obtained lithium-ion battery has a higher drop test pass rate at 55° C., capacity retention rate at the 90th cycle in intermittent cycling test at 40° C., and capacity retention rate after 500 cycles at 40° C. as well as a smaller amount of gas generated at 60° C. This indicates that the drop performance, intermittent cycling performance, cycling performance, and storage performance of the lithium-ion battery at high temperatures are improved.

It can be seen from Example 3-2 and Examples 3-6 to 3-10 that when the mass percentage W5 of 3-(diphenylphosphino)benzenesulfonate lithium falls within the range in this application, the obtained lithium-ion battery has a higher drop test pass rate at 55° C., capacity retention rate at the 90th cycle in intermittent cycling test at 40° C., and capacity retention rate after 500 cycles at 40° C. as well as a smaller amount of gas generated at 60° C. This indicates that the drop performance, intermittent cycling performance, cycling performance, and storage performance of the lithium-ion battery at high temperatures are improved.

It can be seen from Example 2-19, Example 2-20, Example 2-3, Example 3-3, and Examples 3-11 to 3-13 that ethylene sulfate, vinylene sulfate, the nitrile compound, the fluorine compound, and 3-(diphenylphosphino)benzenesulfonate lithium have good synergistic effects. When the electrolyte includes the above substances, the obtained lithium-ion battery has a higher drop test pass rate at 55° C., capacity retention rate at the 90th cycle in intermittent cycling test at 40° C., and capacity retention rate after 500 cycles at 40° C. as well as a smaller amount of gas generated at 60° C. This indicates that the drop performance, intermittent cycling performance, and cycling performance of the lithium-ion battery at high temperatures are improved.

It should be noted that relational terms such as first and second herein are only used to distinguish one entity or operation from another entity or operation region and do not necessarily require or imply any such actual relationship or order between these entities or operations. In addition, the terms “include”, “comprise”, or any other variations thereof are intended to cover a non-exclusive inclusion, so that a process, a method, or an item including a series of elements not only includes those elements but also includes other elements that are not expressly listed, or further includes elements inherent to such process, method, or item.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A separator, comprising a polyethylene base film and a coating provided on at least one surface of the polyethylene base film, wherein a pore closing temperature of the separator is T1, a pore closing temperature of the polyethylene base film is T2, and 3° C.≤T2−T1≤17° C.; and
the separator has a porosity P of 15% to 55% after being placed at 110° C. for 10 min.

2. The separator according to claim 1, wherein 132° C.≤T1≤142° C., and/or 136° C.≤T2≤146° C.

3. The separator according to claim 1, wherein 25%≤P≤45%.

4. The separator according to claim 1, wherein after the separator is placed at 110° C. for 30 min, an area percentage of the molten coating covering the polyethylene base film is A, and 72%≤A≤85%.

5. The separator according to claim 4, wherein the coating comprises a first material and a second material; a melt flow rate MFR1 of the first material is 8 g/10 min to 17 g/10 min; and a melt flow rate MFR2 of the second material is 0.5 g/10 min to 2.5 g/10 min.

6. The separator according to claim 5, wherein the first material and the second material are each independently selected from at least one of polyethylene or polypropylene.

7. The separator according to claim 5, wherein a mass ratio of the first material to the second material is 1:(1 to 4.5).

8. A secondary battery, comprising a positive electrode plate, a negative electrode plate, an electrolyte, and the separator according to claim 1.

9. The secondary battery according to claim 8, wherein the electrolyte comprises a lithium salt, a solvent, and an additive; and the additive comprises ethylene sulfate and vinylene sulfate; and
based on a total mass of the electrolyte, a mass percentage of ethylene sulfate is W1, and a mass percentage of vinylene sulfate is W2, wherein 0.1≤W1/W2≤2, and 0.2%≤W1≤1%.

10. The secondary battery according to claim 9, wherein 0.5%≤W2≤2%.

11. The secondary battery according to claim 8, wherein the electrolyte further comprises a nitrile compound and a fluorine compound; and based on the total mass of the electrolyte, a mass percentage of the nitrile compound is W3, and a mass percentage of the fluorine compound is W4, wherein 0.28≤W3/W4≤2, and 0.6%≤W4≤4.2%;
the nitrile compound comprises at least one of a compound represented by formula [1] or a compound represented by formula [2]:
CN-R1-CN formula [1]; and
CN-R2-(O-R3)n-O-R4-CN formula [2];
wherein R1, R2, R3, and R4 are each independently an alkylene group with 1 to 5 carbon atoms or an alkenylene group with 2 to 5 carbon atoms, and n represents an integer from 0 to 5; and
the fluorine compound comprises at least one of fluoroethylene carbonate, fluoroethyl methyl carbonate, difluoroethylene carbonate, or 1,1,2,2-tetrafluoroethyl-2,2,3,3-tetrafluoropropyl ether.

12. The secondary battery according to claim 11, wherein the nitrile compound comprises at least one of adiponitrile or butanedinitrile.

13. The secondary battery according to claim 8, wherein the electrolyte further comprises 3-(diphenylphosphino)benzenesulfonate lithium; and based on the total mass of the electrolyte, a mass percentage W5 of 3-(diphenylphosphino)benzenesulfonate lithium is 1% to 4%.

14. The secondary battery according to claim 8, wherein a surface resistance R of the negative electrode plate is 0.002 mΩ/cm² to 0.008 mΩ/cm².

15. An electronic apparatus, comprising a secondary battery; the second battery comprises a separator, wherein the separator comprises a polyethylene base film and a coating provided on at least one surface of the polyethylene base film, wherein a pore closing temperature of the separator is T1, a pore closing temperature of the polyethylene base film is T2, and 3° C.≤T2−T1≤17° C.; and
the separator has a porosity P of 15% to 55% after being placed at 110° C. for 10 min.

16. The electronic apparatus according to claim 15, wherein 132° C.≤T1≤142° C., and/or 136° C.≤T2≤146° C.

17. The electronic apparatus according to claim 15, wherein 25%≤P≤45%.

18. The electronic apparatus according to claim 15, wherein the second battery comprises an electrolyte; the electrolyte comprises a lithium salt, a solvent, and an additive; and the additive comprises ethylene sulfate and vinylene sulfate; and
based on a total mass of the electrolyte, a mass percentage of ethylene sulfate is W1, and a mass percentage of vinylene sulfate is W2, wherein 0.1≤W1/W2≤2, and 0.2%≤W1≤1%.

19. The electronic apparatus according to claim 18, wherein 0.5%≤W2≤2%.

20. The electronic apparatus according to claim 18, wherein the electrolyte further comprises a nitrile compound and a fluorine compound; and based on the total mass of the electrolyte, a mass percentage of the nitrile compound is W3, and a mass percentage of the fluorine compound is W4, wherein 0.28≤W3/W4≤2, and 0.6%≤W4≤4.2%;
the nitrile compound comprises at least one of a compound represented by formula [1] or a compound represented by formula [2]:
CN-R1-CN formula [1]; and
CN-R2-(O-R3)n-O-R4-CN formula [2];
wherein R1, R2, R3, and R4 are each independently an alkylene group with 1 to 5 carbon atoms or an alkenylene group with 2 to 5 carbon atoms, and n represents an integer from 0 to 5; and
the fluorine compound comprises at least one of fluoroethylene carbonate, fluoroethyl methyl carbonate, difluoroethylene carbonate, or 1,1,2,2-tetrafluoroethyl-2,2,3,3-tetrafluoropropyl ether.
